(19) United States
(12) Patent Application Publication
(10) Pub. No.: US 2026/0298708 A1
(43) Pub. Date: Oct. 1, 2026

(54) IDENTIFICATION SUPPORT SYSTEM

(71) Applicant: SHIMADZU CORPORATION, Kyoto-shi (JP)

(72) Inventor: Satoshi SHIMIZU, Kyoto-shi (JP)

(21) Appl. No.: 19/568,248

(22) Filed: Mar. 16, 2026

(30) Foreign Application Priority Data
Mar. 26, 2025 (JP) 2025-052079

(51) Int. Cl. G01J 3/02; G06N 3/0475

(52) U.S. Cl. CPC G01J 3/0264; G06N 3/0475

(57) ABSTRACT

An identification support system includes a processing device that acquires a first identification candidate using analysis data, a generative model, a display, and an input interface that accepts premise information regarding identification. The processing device outputs a first prompt to the generative model, the generative model evaluates validity of the first identification candidate based on the first prompt, and the processing device displays identification support information in which an evaluation result is reflected on the first identification candidate on the display.

### TECHNICAL FIELD

The present disclosure relates to an identification support system that supports the identification of substances contained in a sample.

### BACKGROUND ART

Conventionally, search software utilizing spectral libraries is known as a tool for identifying substances contained in a sample (see Non-Patent Document 1). Also, a technology for extending libraries using machine learning is conventionally known (see Non-Patent Document 2).

### CITATION LIST

### Non-Patent Literature

[Non-Patent Document 1] NIST 08 MS Library and MS Search Program v.2.0f. [online]; The NIST Mass Spectrometry Data Center. [retrieved on Dec. 19, 2024]. Retrieved from the Internet: <URL:https://chemdata.nist.gov/mass-spc/ms-search/docs/Ver20Man.pdf>.
[Non-Patent Document 2] ‘Rapid Prediction of Electron-Ionization Mass Spectrometry Using Neural Networks’ Jennifer N. Wei; David Belanger; Ryan P. Adams; D. Sculley, Mar. 19, 2019, Vol 5/Issue 4, [online]; ACS Central Science. [retrieved on Dec. 19, 2024]. Retrieved from the Internet: <URL: [https://pubs.acs.org/doi/10.1021/acscentsci.9b00085](https://pubs.acs.org/doi/10.1021/acscentsci.9b00085)>.

### SUMMARY OF INVENTION

### Technical Problem

Conventionally, an identification support system presents identification candidates of substances contained in a sample to a user based on analysis data, such as spectral data, obtained by analyzing the sample. However, conventional identification support systems may present substances that are judged by the user to be clearly inappropriate as identification candidates. When a large number of identification candidates including candidates with low validity are presented, there is a problem that the user requires time for identification work.

An object of the present invention is to provide identification support information useful for a user's identification work.

### Solution to Problem

The present disclosure is an identification support system that supports identification of a substance contained in a sample, comprising: a processing device that acquires a first identification candidate of the sample using analysis data obtained by analyzing the sample; a generative model trained to generate a response according to an input prompt; a display; and an input interface, wherein the input interface accepts premise information regarding identification, the processing device generates a prompt and outputs the prompt to the generative model, the prompt includes a first prompt instructing to evaluate validity of the first identification candidate using the premise information, the generative model evaluates the validity of the first identification candidate based on the first prompt and outputs an evaluation result to the processing device, and the processing device generates identification support information in which the evaluation result is reflected on the first identification candidate, and displays the identification support information on the display.

### Advantageous Effects of Invention

According to the present disclosure, identification support information useful for a user's identification work can be provided.

### BRIEF DESCRIPTION OF DRAWINGS

FIG. 1 is a block diagram showing an overall configuration of an identification support system according to Embodiment 1.

FIG. 2 is a flowchart for explaining a processing procedure of the identification support system.

FIG. 3 is a diagram showing an example of a screen accepting input of premise information.

FIG. 4 is a diagram showing an example of a screen in which premise information has been input.

FIG. 5 is a diagram showing an input example of premise information.

FIG. 6 is a diagram showing an example of a first prompt.

FIG. 7 is a diagram showing an example of a second prompt.

FIG. 8 is a diagram showing an example of a calculation formula for calculating a score using spectral similarity and LLM confidence.

FIG. 9 is a diagram showing an example of an identification candidate list displayed on a display.

FIG. 10 is a diagram showing an example of an explanatory text regarding an identification candidate included in the identification candidate list.

FIG. 11 is a flowchart for explaining a processing procedure according to Embodiment 2.

FIG. 12 is a diagram showing an example of a first prompt according to Embodiment 2.

FIG. 13 is a flowchart for explaining a processing procedure according to Embodiment 3.

FIG. 14 is a block diagram showing an overall configuration of an identification support system according to Embodiment 4.

### DESCRIPTION OF EMBODIMENTS

Hereinafter, embodiments will be described in detail with reference to the drawings. Although a plurality of embodiments will be described below, combining configurations described in each embodiment as appropriate is planned from the beginning of the application. Note that the same or corresponding parts in the drawings are denoted by the same reference numerals, and description thereof will not be repeated.

### Embodiment 1

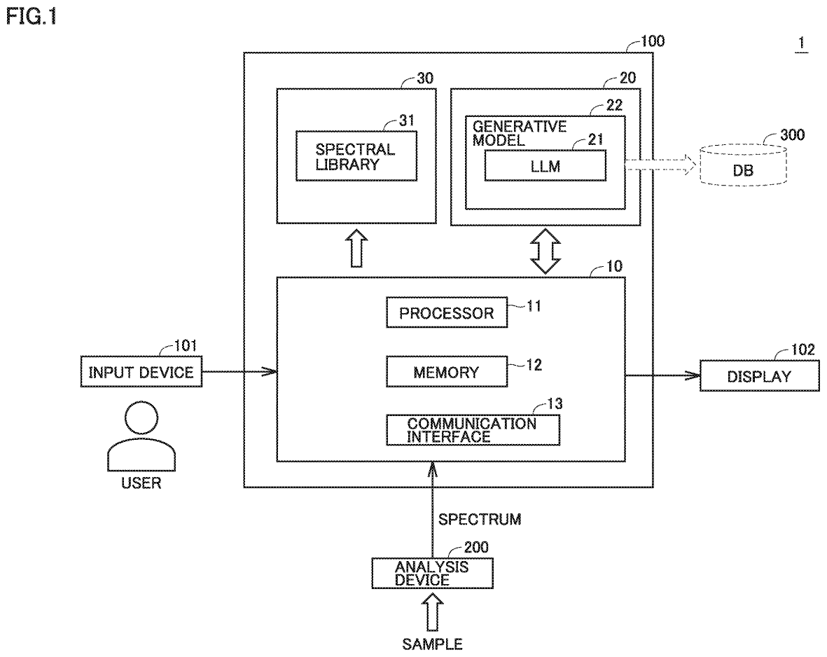

FIG. 1 is a block diagram showing an overall configuration of an identification support system 1. The identification support system 1 supports identification of substances contained in a sample. The identification support system 1 includes an identification support apparatus 100, an input device 101, a display 102, and an analysis device 200. The input device 101 may be a keyboard that accepts a user's operation or a microphone that accepts a user's voice. The input device 101 may be a receiver that accepts data transmitted from an external device, or a reading device that reads data stored in a memory device.

The analysis device 200 may be a gas chromatograph mass spectrometer. Hereinafter, Embodiment 1 will be described taking a case where the analysis device 200 is a gas chromatograph mass spectrometer as an example. Hereinafter, the gas chromatograph mass spectrometer may be abbreviated as GCMS. The analysis device applicable in Embodiment 1 is not limited to GCMS.

Note that the identification support system 1 need not include the analysis device 200. For example, the identification support system 1 may accept a memory device in which an analysis result by the analysis device 200 is stored and acquire the analysis result.

The identification support apparatus 100 may be a personal computer or a server device. The identification support apparatus 100 may be configured by a combination of various devices such as a personal computer and a server device.

The identification support apparatus 100 includes a controller 10 and storages 20, 30. The storages 20, 30 may be an SSD (solid state drive) or an HDD (hard disk drive) or the like. The controller 10 may be a microcomputer. The controller 10 includes a processor 11, a memory 12, and a communication interface 13.

The processor 11 is an example of an arithmetic circuit. The processor 11 is typically configured by a CPU (Central Processing Unit) or an MPU (Multi-Processing Unit) or the like. The processor 11 controls various equipment according to a program.

The memory 12 includes a memory in which a program executed by the processor 11 is stored, and a working memory. The memory 12 includes volatile memories such as a DRAM (dynamic random access memory) and an SRAM (static random access memory), and non-volatile memories such as a ROM (Read Only Memory) and a flash memory. The memory 12 may be an SSD or an HDD or the like.

The communication interface 13 realizes communication between the processor 11 and various devices. The various devices include, for example, the input device 101, the display 102, and the analysis device 200.

The storage 20 stores a generative model 22. The generative model 22 is a model trained in advance by machine learning (trained model). The generative model 22 is trained to generate a response according to an input prompt. Techniques such as deep learning may be used for machine learning of the generative model 22. The generative model 22 includes a Large Language Model (LLM) 21. Hereinafter, the large language model is also referred to as “LLM”. The generative model 22 including the LLM 21 accepts a prompt from the processor 11 included in the controller 10. The generative model 22 operates based on instructions in the prompt and returns a response corresponding to the instructions to the processor 11.

The generative model 22 may be provided with a system (for example, a database) for extending the functions of the LLM 21. The generative model 22 may be functionally extended to process multimodalities such as voice, images, and moving images, for example. In this case, the LLM 21 may accept not only text prompts but also prompts by image, voice, moving image, and text, or a combination thereof, and may return a response by image, voice, moving image, and text, or a combination thereof, to the processor 11 as necessary.

The generative model 22 may be substantially the LLM 21. In this case, as shown in FIG. 1, the generative model 22 may access a database 300 arranged outside the identification support apparatus 100 as necessary to generate an appropriate response corresponding to the input prompt. The generative model 22 may utilize such a database 300 to suppress the occurrence of hallucination. The identification support apparatus 100 may include the database 300 separately from the generative model 22.

The generative model 22 is formed as an autoregressive model using a transformer such as GPT (Generative Pre-trained Transformer), for example. The generative model 22 may be configured by any of Gemini, BERT, etc., in addition to GPT (GPT-4 etc.). The generative model 22 may be customized to appropriately implement processing related to Embodiment 1. The generative model 22 may be a private model assumed to be used only in a specific organization.

The storage 30 stores a spectral library 31. The spectral library 31 stores reference spectra for each chemical substance. A substance contained in a sample is estimated by comparing a spectrum obtained by analyzing the sample with a reference spectrum. The generative model 22 and the spectral library 31 may be stored in a single storage.

The spectral library 31 stores data for calculating spectral similarity. Spectral similarity is the similarity between a spectrum obtained by analyzing a sample and a reference spectrum.

Hereinafter, an outline of the processing of the identification support system 1 will be described. The analysis device 200 analyzes a sample to be identified and outputs analysis data as an analysis result to the identification support apparatus 100. When the analysis device 200 is a GCMS, the analysis data may be spectral data.

The processor 11 refers to the storage 30 and selects a candidate for a chemical substance corresponding to the input spectral data from the spectral library 31. Hereinafter, the “selected candidate for a chemical substance” is referred to as an “identification candidate”. The identification candidate can be an identification candidate presented to the user by the identification support system 1. The processor 11 may select one or more candidates for a chemical substance corresponding to the input spectral data. The processor 11 is an example of a processing device that acquires an identification candidate of a sample using analysis data obtained by analyzing the sample. Such a processor may be referred to as Control Circuitry.

The processor 11 may input the spectral data acquired from the analysis device 200 into the generative model 22 and instruct the generative model 22 to determine an identification candidate. In this case, the identification support apparatus 100 need not include the spectral library 31. If an appropriate identification candidate cannot be obtained with the spectral library 31, the processor 11 may input the spectral data acquired from the analysis device 200 into the generative model 22 and instruct the generative model 22 to determine an identification candidate.

The input device 101 accepts input of premise information regarding identification. For example, the user may input the premise information by operating a keyboard. The processor 11 instructs the generative model 22 to evaluate the possibility that the identification candidate is obtained from the sample based on the premise information. Hereinafter, the “possibility that the identification candidate is obtained from the sample” is also referred to as “validity of the identification candidate”.

The processor 11 generates an identification candidate list to be presented to the user using the evaluation obtained from the generative model 22. The processor 11 displays the identification candidate list on the display 102.

Generally, identification work of a sample is complicated. Therefore, conventionally, an identification device that presents identification candidates to a user using a spectrum obtained by analysis of a sample and a spectral library has been widely used. This type of identification device calculates similarity between a spectrum to be identified and data in the spectral library, lists substances with high similarity, and presents the list to the user.

However, the lists presented by this type of conventional identification device have had various problems. For example, there have been cases where a large number of substances determined by the user to clearly lack validity exist at the top of the list, or cases where substances with high validity are not aligned at the top of the list. Therefore, it took time for the user to scrutinize the list.

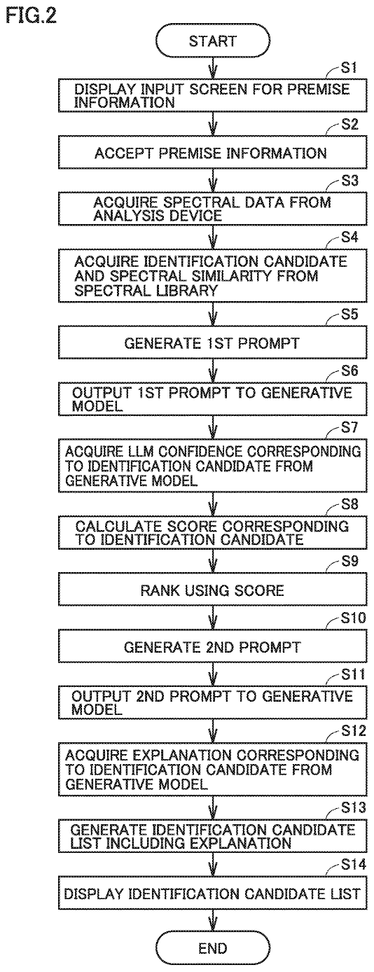

The outline of the processing of the identification support system 1 has been described above with reference to FIG. 1. Hereinafter, processing of the identification support system 1 for solving such conventional problems will be described in detail with reference to FIGS. 2 to 10.

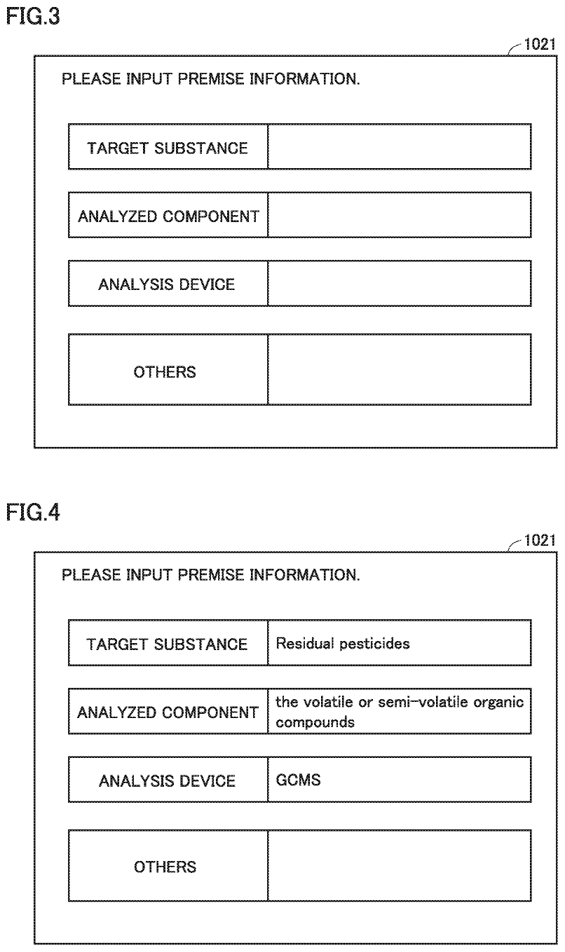

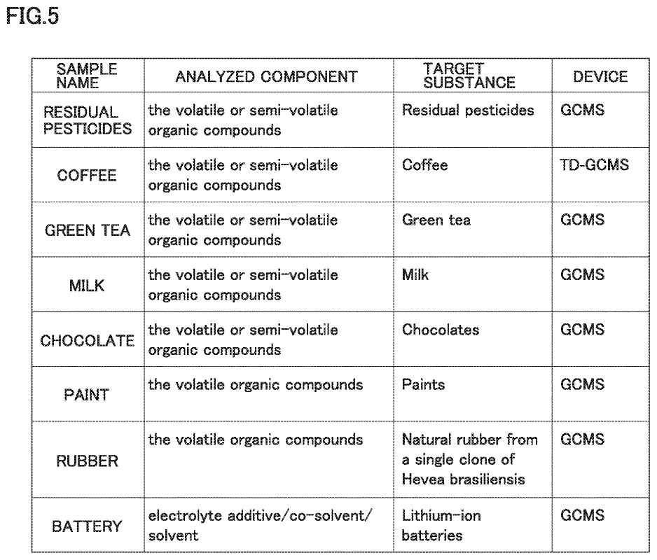

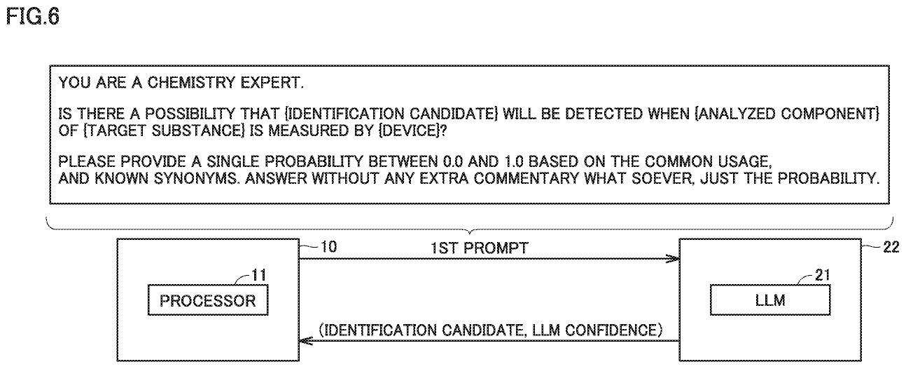

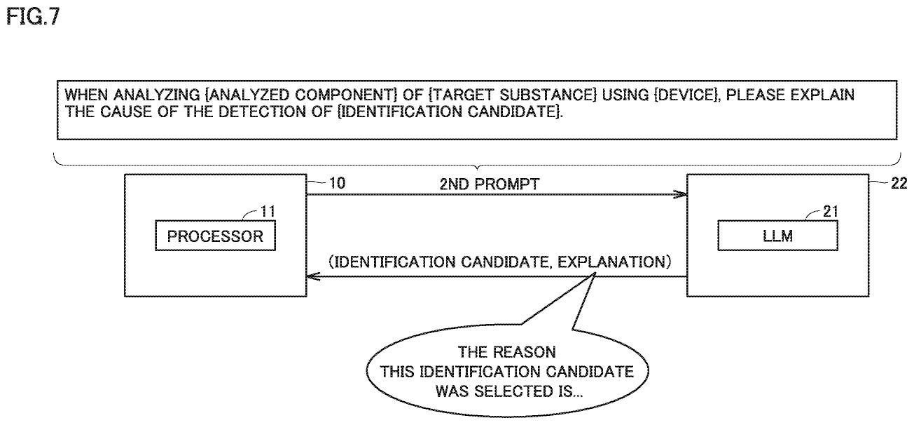

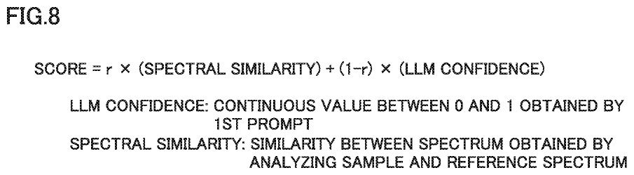

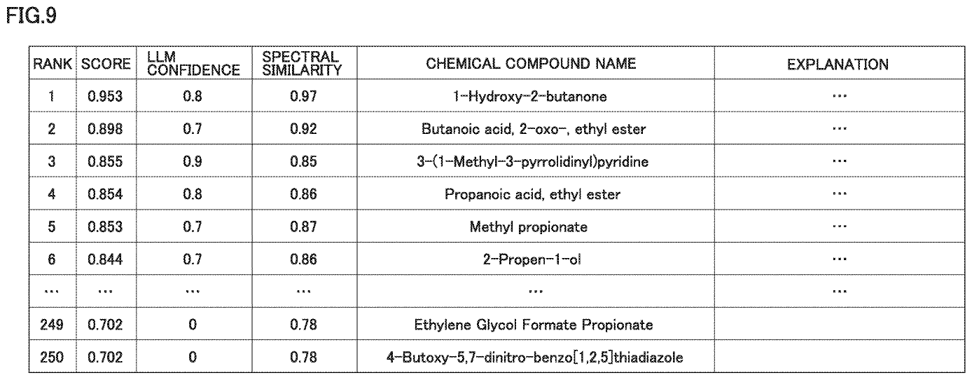

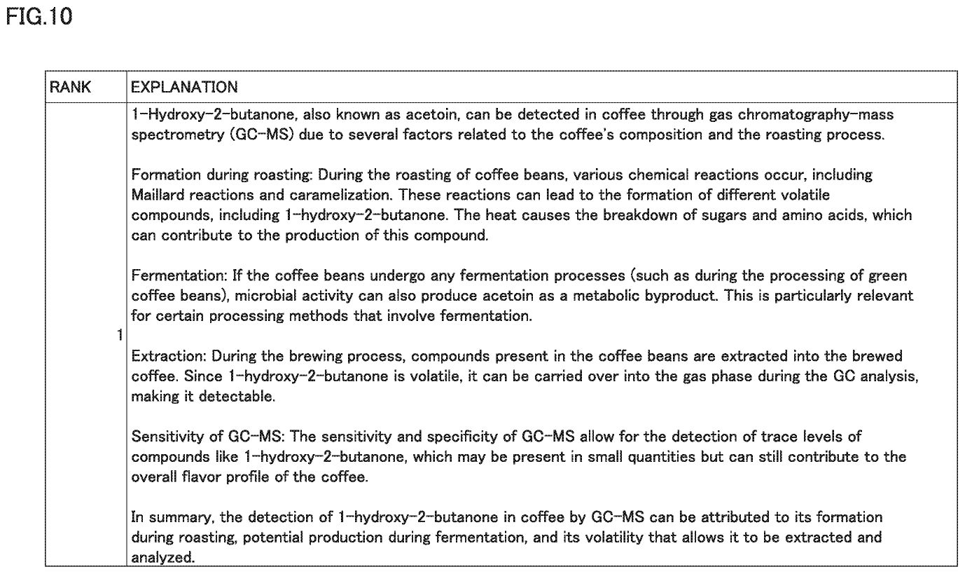

FIG. 2 is a flowchart for explaining a processing procedure of the identification support system 1. FIG. 3 is a diagram showing an example of a screen 1021 accepting input of premise information. FIG. 4 is a diagram showing an example of the screen 1021 in which premise information has been input. FIG. 5 is a diagram showing an input example of premise information. FIG. 6 is a diagram showing an example of a first prompt. FIG. 7 is a diagram showing an example of a second prompt. FIG. 8 is a diagram showing an example of a calculation formula for calculating a score using spectral similarity and LLM confidence. FIG. 9 is a diagram showing an example of an identification candidate list displayed on the display 102. FIG. 10 is a diagram showing an example of an explanatory text regarding an identification candidate included in the identification candidate list.

Hereinafter, the processing procedure of the identification support system 1 will be described according to the flowchart shown in FIG. 2, referring to FIGS. 3 to 10 as necessary. The processing based on the flowchart shown in FIG. 2 is mainly executed by the processor 11. However, the processing of the processor 11 in Embodiment 1 can also be understood as processing of the controller 10.

### Accepting Premise Information

First, the processor 11 displays a screen for inputting premise information to the user (step S1). In FIG. 3, the screen 1021 accepting input of premise information is shown. Premise information is information premised when identifying a substance contained in a sample. As shown in FIG. 3, the premise information includes information on “Target Substance”, information on “Analyzed Component”, and information on “Analysis Device”. “Target Substance” means a sample to be identified. “Analyzed Component” means a component extracted from a sample to analyze the sample. “Analysis Device” means an analysis device used for analysis of a sample.

As shown in FIG. 3, the screen 1021 may be provided with an area accepting user input of information regarding “Others”. “Others” is, for example, arbitrary information. Arbitrary information may be, for example, the purpose of identification, or a technical field in which the target substance is utilized, etc.

In FIG. 5, an input example combining “Target Substance”, “Analyzed Component”, and “Analysis Device” is shown. For example, when the sample is residual pesticide, the user may set “Target Substance” to “Residual pesticides”, “Analyzed Component” to “the volatile or semi-volatile organic compounds”, and “Analysis Device” to “GCMS”. Alternatively, when the sample is residual pesticide, the user may set “Target Substance” to “Coffee”, “Analyzed Component” to “the volatile or semi-volatile organic compounds”, and “Analysis Device” to “TD-GCMS”.

In FIG. 4, an input example of premise information when the sample is residual pesticide is shown. The identification support system 1 generates identification support information to be presented to the user using analysis data (for example, spectral data) acquired from the analysis device 200 and the premise information provided by the user. When information is input in the “Others” area, the identification support system 1 may process the information input in the “Others” area as part of the premise information.

### Acquisition of Analysis Data

The processor 11 acquires spectral data from the analysis device 200 (step S3). Spectral data acquired from the analysis device 200 is an example of analysis data. The user may save spectral data output from the analysis device 200 to a recording medium. In this case, the processor 11 may access the recording medium to acquire the spectral data.

### Acquisition of Identification Candidate and Spectral Similarity

The processor 11 refers to the storage 30 and acquires identification candidates and spectral similarities from the spectral library 31 (step S4). More specifically, the processor 11 inputs the spectral data acquired in step S3 into the spectral library 31. The spectral library 31 calculates the similarity between the spectrum of the input data and a reference spectrum, and selects identification candidates. The spectral library 31 outputs the selected identification candidates together with spectral similarities to the processor 11. The spectral library 31 is an example of “data for specifying a correspondence relationship between analysis data and identification candidates”.

The processor 11 stores the acquired identification candidates in association with the spectral similarities in the memory 12 (see FIG. 1). Note that the processor 11 may access the spectral library 31 and execute calculation processing of spectral similarity and selection processing of identification candidates. Spectral similarity represents, for example, validity of an identification candidate. Spectral similarity may be, for example, cosine similarity.

The number of identification candidates acquired from the spectral library 31 will differ depending on the spectral data acquired in step S3 and the library configuration of the spectral library 31. A plurality of identification candidates with identical or different spectral similarities may be acquired from the spectral library 31. Alternatively, one identification candidate may be acquired from the spectral library 31. The one or more identification candidates acquired in step S4 are an example of a first identification candidate. Hereinafter, description will be continued taking as an example a case where a plurality of identification candidates with different spectral similarities are acquired from the spectral library 31.

### Processing Using First Prompt

The processor 11 generates a first prompt using the premise information accepted in step S2 and the identification candidates acquired in step S4 (step S5). In FIG. 6, an example of the first prompt is shown. The first prompt is generated to cause the generative model 22 to answer the validity of the identification candidate acquired in step S4 from the viewpoint of the premise information. The first prompt shown in FIG. 6 includes an instruction to seek the possibility (validity) that the “identification candidate” is detected when the “analyzed component” of the “target substance” is analyzed by the “device”.

Furthermore, the first prompt includes an instruction to answer the possibility that the “identification candidate” is detected with a single probability as a numerical value between 0.0 and 1.0. As shown in FIG. 6, the first prompt may include an instruction asking to answer based on common usage and known synonyms, or may include an instruction asking to answer only the probability without putting in any additional comments.

The processor 11 outputs the generated first prompt to the generative model 22 (step S6). The generative model 22 evaluates the validity of the identification candidate based on the first prompt and outputs an evaluation result to the processor 11. As shown in FIG. 6, the generative model 22 that acquired the first prompt returns a response including, for example, the identification candidate to be evaluated and an LLM confidence to the processor 11. The LLM confidence is a numerical value between 0.0 and 1.0. The LLM confidence is an example of an evaluation result.

Thereby, the processor 11 acquires the LLM confidence corresponding to the identification candidate from the generative model 22 (step S7). The processor 11 stores the acquired LLM confidence in association with the identification candidate in the memory 12. The LLM confidence is an example of first numerical information indicating the validity of the identification candidate. The spectral similarity is an example of second numerical information indicating the validity of the identification candidate.

When a plurality of identification candidates are acquired in step S4, the processor 11 executes the processing of steps S5 to S7 for each identification candidate. Thereby, spectral similarity and LLM confidence are stored for each identification candidate in the memory 12.

### Generation of Score and Ranking

The processor 11 calculates a score corresponding to the identification candidate using the spectral similarity and the LLM confidence (step S8). In FIG. 8, an example of a calculation formula for calculating the score is shown. As shown in FIG. 8, the processor 11 derives the score by calculating “r×(spectral similarity)+(1-r)×(LLM confidence)”. Here, “r” is a weight. “r” is a numerical value between 0.0 and 1.0.

Thus, the score is a weighted average value calculated using the spectral similarity and the LLM confidence. The processor 11 generates a score indicating the validity of the identification candidate using the spectral similarity and the LLM confidence.

Spectral similarity is a value obtained by actually measuring a sample. On the other hand, LLM confidence is a value output from the generative model 22. The generative model 22 does not utilize values obtained by actually measuring the sample when computing the LLM confidence. It can be said that the accuracy of LLM confidence output from a generative model trained by effective machine learning is generally high. Therefore, the LLM confidence output from such a highly reliable generative model is a useful index for the user to judge the validity of an identification candidate.

However, even if a highly reliable generative model is used, it is not possible with current technology to completely avoid the generative model deriving a false negative conclusion. Therefore, there is a possibility that the generative model outputs a low LLM confidence for an identification candidate for which a high LLM confidence should naturally be output. Therefore, it is not desirable to completely trust the LLM confidence.

Therefore, it is desirable to introduce a score for comprehensively judging the validity of an identification candidate using the spectral similarity, the LLM confidence, and an appropriate weight. For example, basically, emphasis may be placed on spectral similarity, and the score may be calculated using LLM confidence for fine adjustment. In such a case, the weight (r) shown in FIG. 8 is desirably 0.5 or more. The weight is more desirably 0.9.

However, the weight may be a value exceeding 0 and less than 0.5. The weight may be a value exceeding 0.9 and less than 1. The identification support apparatus 100 may accept an operation by the user to set the weight to a desired value.

The processor 11 ranks the identification candidates using the score (step S9). More specifically, the processor 11 sets a rank for the identification candidates in descending order of the score.

### Processing Using Second Prompt

The processor 11 generates a second prompt using the premise information accepted in step S2 and the identification candidates acquired in step S4 (step S10). When a plurality of identification candidates are acquired in step S4, the processor 11 may generate the second prompt using a part of the plurality of identification candidates.

For example, the processor 11 may generate the second prompt targeting a reference number of top identification candidates among the identification candidates ranked in step S9. For example, the reference number may be 10. The processor 11 may generate the second prompt targeting identification candidates exceeding a reference score value among the identification candidates ranked in step S9.

In FIG. 7, an example of the second prompt is shown. The second prompt is generated to cause the generative model 22 to answer an explanation regarding the identification candidate acquired in step S4 from the viewpoint of the premise information. The second prompt shown in FIG. 7 includes an instruction to seek an explanation of the cause for the “identification candidate” being detected when the “analyzed component” of the “target substance” is analyzed using the “device”. In short, the second prompt instructs the generative model 22 to answer the reason why the generative model 22 selects the “identification candidate” based on the “premise information”.

Since generative models can derive highly reliable conclusions by utilizing advanced computational capabilities, they are utilized in various fields. However, as described above, it cannot be completely avoided that a generative model leads to an invalid conclusion. Therefore, in the present embodiment, the calculation method of the score corresponding to the identification candidate is devised. However, since the LLM confidence obtained from the generative model is reflected in the score, the accuracy of the score decreases if the LLM confidence is not valid.

Generally, since the answer process of a generative model is often a black box, it may be difficult for a user to understand the basis on which the LLM confidence was obtained from a human thought process. This is known as the problem of “explainability”. Therefore, although the calculation method of the score corresponding to the identification candidate is devised, it cannot be said that it is desirable for the user to perform identification work relying only on the score.

Therefore, in Embodiment 1, in order to resolve such a problem of “explainability”, the generative model 22 is made to answer the reason why the generative model 22 selects the “identification candidate” based on the “premise information”. That is, in Embodiment 1, the “explanation” obtained from the generative model 22 by the second prompt is an example of “information for evaluating validity of an identification candidate” similarly to the “rank”.

The processor 11 outputs the second prompt to the generative model 22 (step S11). The generative model 22 generates an explanation based on the second prompt and outputs the generated explanation to the processor 11. As shown in FIG. 7, the generative model 22 that acquired the second prompt returns a response including, for example, the identification candidate to be explained and the explanation to the processor 11. Note that the generative model 22 may include an LLM confidence of the generated explanation in the response. The generative model 22 may reply with a plurality of explanations together with LLM confidence for each explanation to the processor 11.

Next, the processor 11 acquires the explanation corresponding to the identification candidate from the generative model 22 (step S12). The processor 11 stores the acquired explanation in association with the identification candidate in the memory 12.

When a plurality of identification candidates are acquired in step S4, the processor 11 executes the processing of steps S10 to S12 for each identification candidate. Thereby, explanations of identification candidates are stored for each identification candidate in the memory 12.

### Generation and Display of Identification Candidate List

The processor 11 refers to the memory 12 and generates a list of identification candidates including explanations of the identification candidates (step S13). Next, the processor 11 displays the list of identification candidates on the display 102 (step S14). The display 102 may be connected to the identification support apparatus 100 via a network such as the Internet. In this case, the processor 11 outputs the list of identification candidates to the network.

In FIG. 9, an example of an identification candidate list obtained when targeting each of “Target Substance”, “Analyzed Component”, and “Device” corresponding to the sample name “Coffee” among the input examples shown in FIG. 5 is shown. For example, the identification candidate list includes “Rank” indicating the height of validity of the identification candidate, “Score” corresponding to the identification candidate, “LLM Confidence” corresponding to the identification candidate, “Spectral Similarity” corresponding to the identification candidate, “Compound Name” corresponding to the identification candidate, and “Explanation” corresponding to the identification candidate. As already explained, the rank is based on the score, and the score is a numerical value calculated based on the spectral similarity and the LLM confidence.

In FIG. 10, as an example, an explanation of the identification candidate (1-Hydroxy-2-butanone) corresponding to “Rank 1” of the identification candidate list shown in FIG. 9 is shown. The explanation roughly includes the following matters.
The identification candidate 1-Hydroxy-2-butanone can be detected from coffee by gas chromatography mass spectrometry due to several factors related to coffee components and the roasting process.
The identification candidate may be produced by chemical reactions during roasting of coffee beans.
The identification candidate may be produced as a metabolic byproduct when the sample coffee beans undergo a fermentation process of green beans.
The identification candidate may be incorporated into brewed coffee through a coffee extraction process (drip process), and due to having volatility, may be brought into the gas phase during gas chromatography mass spectrometry and detected.
In summary, detection of the identification candidate in coffee by gas chromatography mass spectrometry is considered to be attributed to production during roasting, potential production during fermentation, and volatility of the identification candidate enabling extraction and analysis.

The user can easily and highly accurately perform identification work using the identification candidates displayed on the display 102 while referring to such an explanation, the score, the spectral similarity, and the LLM confidence. The identification candidate list including the score, LLM confidence, spectral similarity, and explanation is an example of identification support information.

According to Embodiment 1, by aligning identification candidates in the list in an order based on the score, identification candidates with relatively high validity surface to the top of the list. Therefore, the user can perform identification work focusing on identification candidates with high validity. Moreover, since the identification candidate list includes explanations regarding identification candidates, the user can perform identification work while utilizing the explanations. Thus, the identification support system 1 according to Embodiment 1 can provide identification support information useful for a user's identification work.

### EMBODIMENT 2

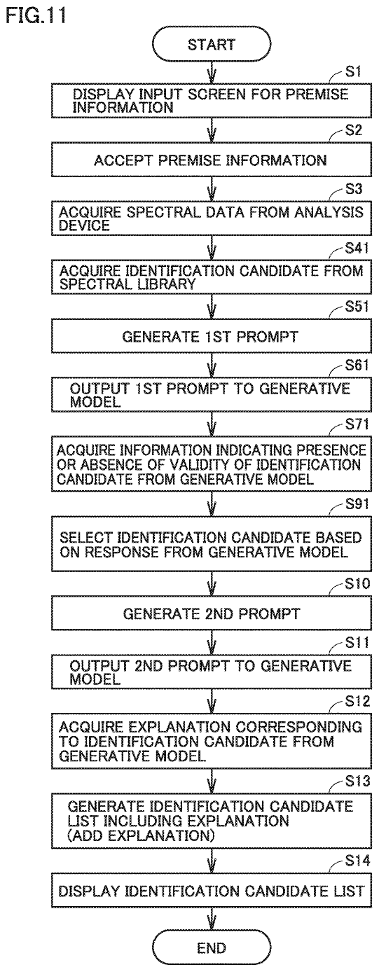

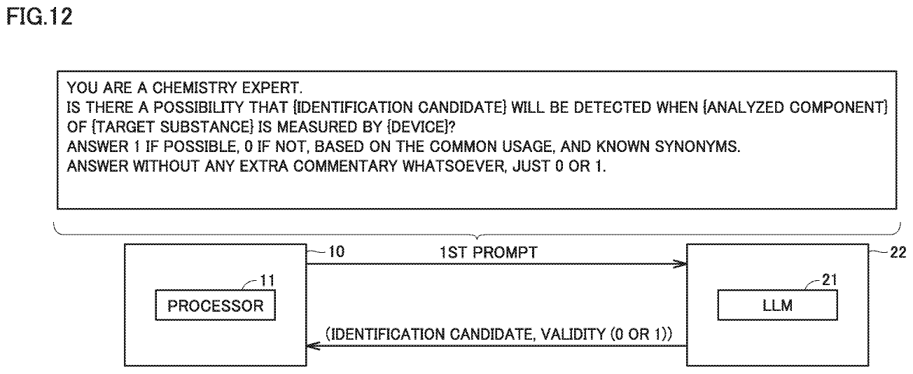

FIG. 11 is a flowchart for explaining a processing procedure according to Embodiment 2. FIG. 12 is a diagram showing an example of a first prompt according to Embodiment 2.

In Embodiment 1, an example in which identification candidates are ordered by score was described. In Embodiment 2, an example will be described in which the generative model 22 is made to answer the presence or absence of validity of an identification candidate, and identification candidates to be posted on the identification candidate list are selected. Note that Embodiment 2 is assumed to adopt the same configuration as Embodiment 1 except for differences in processing shown in the flowchart. In other words, Embodiment 2 should also be understood as a modification of the processing related to the flowchart of Embodiment 1.

Each of steps S1 to S3 and steps S10 to S14 in the flowchart shown in FIG. 11 is the same as the corresponding step in the flowchart shown in FIG. 2. Therefore, description of those steps will not be repeated here.

As shown in FIG. 11, after acquiring spectral data from the analysis device 200, the processor 11 acquires identification candidates corresponding to the spectral data from the spectral library 31 (step S41). The processor 11 may acquire spectral similarity in step S41 similarly to Embodiment 1. In this case, step S41 and step S4 shown in FIG. 2 are the same processing step.

Thereafter, the processor 11 generates a first prompt using the premise information accepted in step S2 and the identification candidates acquired in step S41 (step S51).

In FIG. 12, an example of the first prompt is shown. The first prompt according to Embodiment 2 is generated to cause the generative model 22 to answer the validity of the identification candidate acquired in step S4 from the viewpoint of the premise information, similarly to the first prompt according to Embodiment 2 [sic: likely meant “Embodiment 1”]. However, the first prompt according to Embodiment 2 includes an instruction to seek an answer for the presence or absence of possibility (validity) that the “identification candidate” is detected when the “analyzed component” of the “target substance” is analyzed by the “device”.

As shown in FIG. 12, the first prompt may include an instruction to answer with 1 if there is a possibility that the “identification candidate” is detected, and with 0 if there is no possibility that the “identification candidate” is detected. The first prompt may include an instruction asking to answer based on common usage and known synonyms. The first prompt may include an instruction asking to answer without putting in any additional comments.

The processor 11 outputs the generated first prompt to the generative model 22 (step S61). The generative model 22 evaluates the presence or absence of validity of the “identification candidate” based on the first prompt and outputs an evaluation result to the processor 11. As shown in FIG. 12, the generative model 22 that acquired the first prompt returns a response including, for example, the identification candidate to be evaluated and an evaluation of possibility (0 or 1) to the processor 11. The evaluation of possibility is an example of an evaluation result.

Thereby, the processor 11 acquires information regarding the presence or absence of validity of the identification candidate (0 or 1) from the generative model 22 (step S71). The processor 11 stores the acquired numerical value of 0 or 1 in association with the identification candidate in the memory 12. The acquired numerical value of 0 or 1 is an example of third numerical information indicating the presence or absence of validity of the identification candidate.

When a plurality of identification candidates are acquired in step S4, the processor 11 executes the processing of step S51, step S61, and step S71 for each identification candidate. Thereby, information indicating the presence or absence of validity of the identification candidate is stored for each identification candidate in the memory 12.

Next, the processor 11 selects identification candidates to be posted on the identification candidate list based on the response from the generative model 22 (step S91). More specifically, the processor 11 refers to the memory 12 and sets identification candidates associated with information indicating “presence of validity of identification candidate” as targets for posting to the identification candidate list.

Thereafter, the processor 11 executes the processing of steps S10 to S12 targeting the identification candidates set as posting targets, and acquires explanations corresponding to the identification candidates from the generative model 22. Furthermore, the processor 11 executes the processing of step S13 and step S14 to display an identification candidate list configured by the identification candidates set as posting targets on the display 102.

According to Embodiment 2 described above, the number of identification candidates posted on the identification candidate list can be limited by the generative model 22. In other words, according to Embodiment 2, identification candidates without validity are excluded from the identification candidate list. Therefore, the user can efficiently perform identification work using identification candidates with validity.

### Embodiment 3

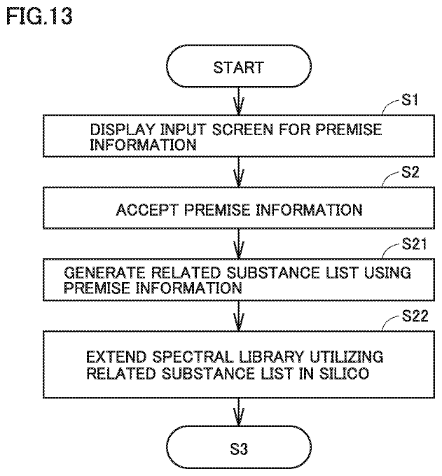

FIG. 13 is a flowchart for explaining a processing procedure according to Embodiment 3. Embodiment 3 is one in which predetermined processing of the processor 11 is added to Embodiment 1 or Embodiment 2. More specifically, in Embodiment 3, step S21 and step S22 are added between step S2 and step S3 of the flowchart shown in FIG. 2 or FIG. 11.

Note that Embodiment 3 is assumed to adopt the same configuration as Embodiment 1 and Embodiment 2 except that the processing shown in the flowchart is added. In other words, Embodiment 3 should also be understood as a modification of Embodiment 1 and Embodiment 2.

As shown in FIG. 13, the processor 11 that accepted the premise information creates a related substance list using the premise information (step S21). The related substance list is used to extend the spectral library 31 (see FIG. 1). The processor 11 may create the related substance list using the premise information by accessing various databases such as “PubChem” and “PubMed”, for example. The processor 11 may instruct the generative model 22 to create a related substance list using the premise information. The processor 11 may output such an instruction to a generative model constructed outside the identification support apparatus 100. The premise information may include, for example, information on “Target Substance”, information on “Analyzed Component”, and information on “Analysis Device”. The premise information may be, for example, the purpose of identification, or a technical field in which the target substance is utilized, etc.

Next, the processor 11 extends the spectral library 31 using the related substance list “In silico” (step S22). Thereby, the processor 11 can acquire identification candidates using the extended spectral library 31 in the processing of step S3 and subsequent steps. As a result, for example, when a correct substance is not included in the initial spectral library 31, the correct substance can be included in the spectral library 31 by extending the spectral library 31. Therefore, according to Embodiment 3, the range of selection of identification candidates can be widened.

### Embodiment 4

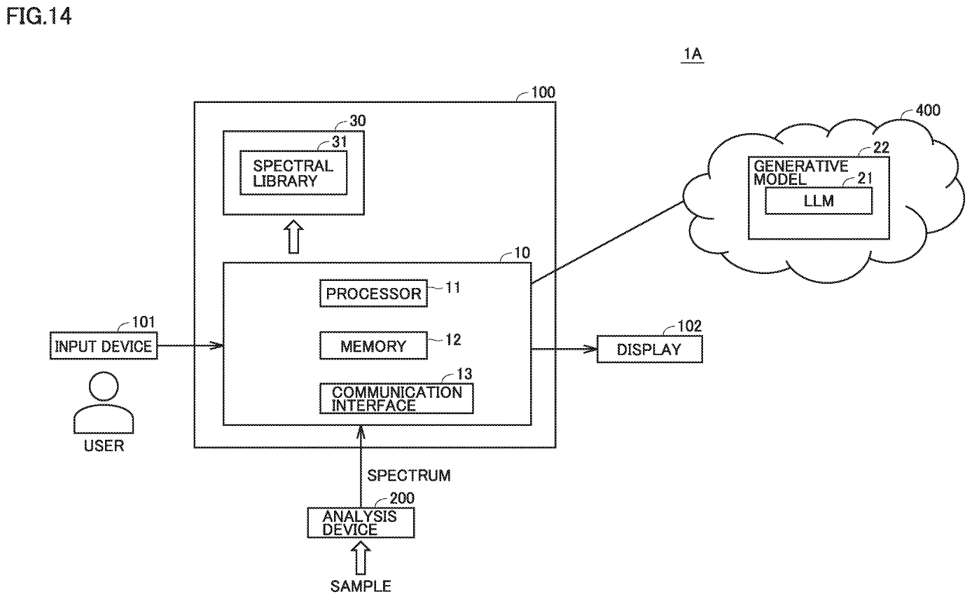

FIG. 14 is a block diagram showing an overall configuration of an identification support system 1A according to Embodiment 4. In the identification support system 1 according to Embodiment 1, the identification support apparatus 100 includes the generative model 22 (see FIG. 1). In contrast, in the identification support system 1A according to Embodiment 4, the generative model 22 is provided in a cloud 400. In this case, the identification support apparatus 100 may access the generative model 22 via a network such as the Internet. Note that the configuration of the identification support system 1A according to Embodiment 4 may also be adopted in Embodiment 2 and Embodiment 3.

### Modifications

In Embodiment 1, the following processing (1) to (4) regarding the first prompt and the second prompt was described.
(1) The processor 11 inputs the first prompt into the generative model 22 and acquires the LLM confidence for the identification candidate from the generative model 22.
(2) The processor 11 calculates a score using the LLM confidence and ranks the identification candidates.
(3) The processor 11 inputs the second prompt into the generative model 22 and acquires an explanation for the identification candidate from the generative model 22.
(4) The processor 11 generates an identification candidate list with explanatory text added. However, instead of inputting the first prompt and the second prompt into the generative model 22, the processor 11 may input a third prompt including instructions related to the first prompt and the second prompt into the generative model 22, and acquire “an identification candidate list with explanatory text added” from the generative model 22. In this case, the third prompt includes an instruction to calculate LLM confidence for identification candidates, an instruction to calculate a score using the LLM confidence, an instruction to rank identification candidates, an instruction to generate an explanation for identification candidates, and an instruction to generate an identification candidate list with explanatory text added.

### ASPECTS

It is understood by those skilled in the art that the above-described embodiments and modifications thereof are specific examples of the following aspects.
(Item 1) An identification support system according to the present disclosure is an identification support system that supports identification of a substance contained in a sample, comprising: a processing device that acquires a first identification candidate of the sample using analysis data obtained by analyzing the sample; a generative model trained to generate a response according to an input prompt; a display; and an input interface, wherein the input interface accepts premise information regarding identification, the processing device generates a prompt and outputs the prompt to the generative model, the prompt includes a first prompt instructing to evaluate validity of the first identification candidate using the premise information, the generative model evaluates the validity of the first identification candidate based on the first prompt and outputs an evaluation result to the processing device, and the processing device generates identification support information in which the evaluation result is reflected on the first identification candidate, and displays the identification support information on the display.

According to the identification support system described in Item 1, identification support information useful for a user's identification work can be provided.
(Item 2) The identification support system described in Item 1, further comprising a storage storing data for specifying a correspondence relationship between the analysis data and the first identification candidate, wherein the processing device refers to the storage to acquire the first identification candidate.

According to the identification support system described in Item 2, the first identification candidate is selected relatively easily by referring to data stored in the storage.
(Item 3) The identification support system described in Item 1 or Item 2, wherein the prompt includes a second prompt instructing to generate an explanation regarding the first identification candidate using the premise information, the generative model generates an explanation regarding the first identification candidate based on the second prompt and outputs the explanation regarding the first identification candidate to the processing device, and the identification support information includes the explanation regarding the first identification candidate.

According to the identification support system described in Item 3, information useful for identification work can be provided to the user.
(Item 4) The identification support system described in Item 3, wherein the explanation regarding the first identification candidate includes a reason why the first identification candidate is selected based on the premise information.

According to the identification support system described in Item 4, useful information regarding validity of the first identification candidate can be provided to the user.
(Item 5) The identification support system described in Item 2, wherein the evaluation result includes first numerical information indicating validity of the first identification candidate, the processing device acquires second numerical information indicating validity of the first identification candidate when selecting the first identification candidate by referring to the storage, the processing device generates third numerical information indicating validity of the first identification candidate using the first numerical information and the second numerical information, and the identification support information includes the third numerical information.

According to the identification support system described in Item 5, useful information regarding validity of an identification candidate can be provided to the user.
(Item 6) The identification support system described in Item 5, wherein the first identification candidate includes a plurality of identification candidates for which corresponding third numerical information is respectively different, and the identification support information includes a list in which the plurality of identification candidates are arranged according to the third numerical information.

According to the identification support system described in Item 6, the user can easily confirm identification candidates based on the height of validity of the identification candidates.
(Item 7) The identification support system described in Item 5 or Item 6, wherein the identification support information includes the first numerical information, the second numerical information, and the third numerical information.

According to the identification support system described in Item 7, a plurality of information useful for judging validity of an identification candidate can be provided to the user.
(Item 8) The identification support system described in any one of Items 5 to 7, wherein the analysis data is spectral data acquired by analyzing the sample, the first numerical information is a confidence output from the generative model, the second numerical information is a spectral similarity, and the third numerical information is a weighted average value calculated using the first numerical information and the second numerical information.

According to the identification support system described in Item 8, by appropriately setting the weight when calculating the weighted average, more useful information regarding validity of an identification candidate can be provided to the user.
(Item 9) The identification support system described in any one of Items 1 to 4, wherein the first identification candidate includes a plurality of identification candidates, the evaluation result includes fourth numerical information indicating presence or absence of validity of each of the plurality of identification candidates, the processing device selects a second identification candidate from among the plurality of identification candidates using the fourth numerical information, and the identification support information is information on the second identification candidate.

According to the identification support system described in Item 9, since identification candidates that the user should examine can be reduced, the labor of the user's identification work can be reduced.
(Item 10) The identification support system described in Item 2, wherein the processing device generates a substance list related to the premise information, and extends the data stored in the storage using the substance list.

According to the identification support system described in Item 10, by using extended data, more appropriate identification candidates can be extracted.

### REFERENCE SIGNS LIST

1, 1A Identification support system, 10 Controller, 11 Processor (Processing device), 12 Memory, 13 Communication interface, 20, 30 Storage, 21 LLM, 22 Generative model, 31 Spectral library, 100 Identification support apparatus, 101 Input device, 102 Display, 200 Analysis device, 300 Database, 400 Cloud, 1021 Screen.

1. An identification support system that supports identification of a substance contained in a sample, comprising:
a processing device that acquires a first identification candidate of the sample using analysis data obtained by analyzing the sample;
a generative model trained to generate a response according to an input prompt;
a display; and
an input interface, wherein
the input interface accepts premise information regarding the identification,
the processing device generates a prompt and outputs the prompt to the generative model,
the prompt includes a first prompt instructing to evaluate validity of the first identification candidate using the premise information,
the generative model evaluates the validity of the first identification candidate based on the first prompt and outputs an evaluation result to the processing device, and
the processing device generates identification support information in which the evaluation result is reflected on the first identification candidate, and displays the identification support information on the display.

2. The identification support system according to claim 1, further comprising a storage storing data for specifying a correspondence relationship between the analysis data and the first identification candidate, wherein
the processing device refers to the storage to acquire the first identification candidate.

3. The identification support system according to claim 1, wherein
the prompt includes a second prompt instructing to generate an explanation regarding the first identification candidate using the premise information,
the generative model generates an explanation regarding the first identification candidate based on the second prompt and outputs the explanation regarding the first identification candidate to the processing device, and
the identification support information includes the explanation regarding the first identification candidate.

4. The identification support system according to claim 3, wherein
the explanation regarding the first identification candidate includes a reason why the first identification candidate is selected based on the premise information.

5. The identification support system according to claim 2, wherein
the evaluation result includes first numerical information indicating validity of the first identification candidate,
the processing device acquires second numerical information indicating validity of the first identification candidate when selecting the first identification candidate by referring to the storage,
the processing device generates third numerical information indicating validity of the first identification candidate using the first numerical information and the second numerical information, and
the identification support information includes the third numerical information.

6. The identification support system according to claim 5, wherein
the first identification candidate includes a plurality of identification candidates for which corresponding third numerical information is respectively different, and
the identification support information includes a list in which the plurality of identification candidates are arranged according to the third numerical information.

7. The identification support system according to claim 5, wherein
the identification support information includes the first numerical information, the second numerical information, and the third numerical information.

8. The identification support system according to claim 5, wherein
the analysis data is spectral data acquired by analyzing the sample,
the first numerical information is a confidence output from the generative model,
the second numerical information is a spectral similarity, and
the third numerical information is a weighted average value calculated using the first numerical information and the second numerical information.

9. The identification support system according to claim 1, wherein
the first identification candidate includes a plurality of identification candidates,
the evaluation result includes fourth numerical information indicating presence or absence of validity of each of the plurality of identification candidates,
the processing device selects a second identification candidate from among the plurality of identification candidates using the fourth numerical information, and
the identification support information is information on the second identification candidate.

10. The identification support system according to claim 2, wherein
the processing device generates a substance list related to the premise information, and extends the data stored in the storage using the substance list.
